(19) United States
(12) Patent Application Publication
(10) Pub. No.: US 2025/0362977 A1
(43) Pub. Date: Nov. 27, 2025

(54) SYSTEMS AND METHODS FOR REGISTERING DETAILS OF INTELLIGENT COMMUNICATIVE AGENTS

(71) Applicant: Affle (India) Limited, India, Gurugram (IN)

(72) Inventors: Anuj Khanna SOHUM, Singapore (SG); Charles Yong Jien FOONG, Templestowe (AU); Madhusudana RAMAKRISHNA, Singapore (SG)

(73) Assignee: Affle (India) Limited, India, Gurugram (IN)

(21) Appl. No.: 19/216,165

(22) Filed: May 22, 2025

(30) Foreign Application Priority Data
May 22, 2024 (IN) 202311079244

(51) Int. Cl. G06F 9/54; G06N 3/092

(52) U.S. Cl. CPC G06F 9/54; G06N 3/092; G06F 2209/544

(57) ABSTRACT

Systems and methods for registering intelligent communicative agents are disclosed. The system registers intelligent communicative agents, where the register may serve as a centralized repository for accurate agent identification and management. This register meticulously stores the specific attributes of each agent, including its precise location within the system. The system functions as a central hub for storing comprehensive details about each agent, such as its training data, the volume of data it requires for optimal performance, and its interactions with other agents. Further the system streamlines the process of discovering, assessing, and overseeing agents, ensuring a structured and efficient approach to their management.

### CROSS REFERENCE TO RELATED APPLICATIONS

This patent application claims priority to Indian Patent Application No. IN 202311079244, filed May 22, 2024, entitled “SYSTEMS AND METHODS FOR REGISTRY OF ARTIFICIAL INTELLIGENCE (AI) AGENTS” and assigned to the assignee hereof. The disclosure of the prior application is considered part of and is incorporated by reference in this patent application.

### TECHNICAL FIELD

Embodiments of the present disclosure generally relate to artificial intelligence (AI) based systems and more particularly to systems and methods for registering details of one or more intelligent communicative agents.

### BACKGROUND

As artificial intelligence (AI) technologies continue to evolve and proliferate, there is a growing need for a structured and comprehensive registry system to manage AI agents effectively. The need for such a registry system arises from several key factors. Firstly, the AI landscape has witnessed a rapid proliferation of AI agents, ranging from simple task-specific agents to highly complex and sophisticated models. With this proliferation comes the challenge of efficiently managing and categorizing these agents, which can vary in terms of capabilities, data requirements, and purposes.

Secondly, AI agents are becoming integral components of various applications services across different domains, including healthcare, finance, customer service, and more. To ensure responsible and ethical use of AI, it is essential to establish a transparent and accountable system for registering and monitoring these agents.

Moreover, the AI community faces issues related to transparency, accountability, and responsible AI usage. Ethical concerns, potential biases, and unintended consequences of AI applications underscore the need for a robust framework that allows for the identification and management of AI agents. A comprehensive registry can enhance transparency by providing details about an AI agent's development, training data, and intended use cases, enabling users to assess potential ethical and bias-related risks.

Furthermore, there is a need for continuous improvement in the way AI agents are tracked, updated, and monitored. As AI technology advances, it is essential to have a dynamic and adaptable registry system that accommodates the evolving landscape of AI agents and their associated challenges.

Consequently, it is evident that in order to address the above-mentioned limitations, there is a pressing need for improved systems and methods for registering artificial intelligence (AI) agents.

### OBJECTS OF THE INVENTION

Some of the objects of the present disclosure, which at least one embodiment herein satisfy, are listed herein below.

It is an object of the present subject matter to overcome the afore mentioned and other drawbacks existing in the prior art systems and methods.

It is a significant object of the present subject matter to design and develop a system and an associated method that is capable of registering details of one or more intelligent communicative agents.

It is another principal object of the present subject matter to design and develop the system such that the system has a central repository to record, store and manage information related to the one or more intelligent communicative agents.

It is another principal object of the present subject matter to design and develop the system such that the system facilitates compartmentalized processing of information by intelligent communicative agents to prevent overlapping actions.

It is another object of the present subject matter to design and develop the system where the system facilitates storage of comprehensively categorized data crucial for agent operation and governance. This includes Factual Immutable data (e.g., foundational knowledge like date of birth, immutable agent identifiers), Factual Mutable data (e.g., transient information like current location, real-time operational parameters), Historical Preferences and Behaviors (e.g., past user choices, logged system interactions), Current Preferences (e.g., explicitly stated contemporary choices or settings), as well as Inferred data (e.g., insights derived from actions, behaviors, and historical data) generated as a result of training or operation of intelligent communicative agents.

It is another object of the present subject matter to design and develop the system where the system ensures response quality, personalization and evolution of communicative agent's behavior over time.

It is even another object of the present subject matter to design and develop the system such that the system is simple to implement.

These and other objects and advantages of the present subject matter will be apparent to a person skilled in the art after consideration of the following detailed description, taken into consideration with accompanied drawings in which preferred embodiments of the present subject matter are illustrated.

### SUMMARY OF THE INVENTION

This summary is provided to introduce concepts related to a system for registering details of one or more intelligent communicative agents. The concepts are further described below in the detailed description. This summary is not intended to identify key features or essential features of the claimed subject matter, nor is it intended to be used to limit the scope of the claimed subject matter.

According to an embodiment, there is provided a system for registering details of one or more intelligent communicative agents.

In an aspect, the system comprises one or more intelligent communicative agents, configured to be associated with scope of a predefined field, a memory unit configured to store information related to the one or more intelligent communicative agents, one or more processors configured to facilitate interaction between one or more intelligent communicative agents, generate real time information based on interaction between the one or more intelligent communicative agents to ensure functioning of the one or more intelligent communicative agents in a cohesive manner, a central hub configured to receive and process information related to interactions between the one or more intelligent communicative agents from the one or more processors, an intelligent communicative agent register, where the intelligent communicative agent register acts as a central repository and is configured to receive information from the central hub and the one or more processors, record, store and manage information related to each intelligent communicative agent of the one or more intelligent communicative agents, one or more communication networks configured to facilitate transmission of information between the one or more intelligent communicative agents, the central hub and the intelligent communicative agent register, receive as generated real time information by the intelligent communicative agent register, transmit as received real-time information to one or more user devices communicatively coupled to the system and a database configured to receive information from the system by means of the one or more communication networks and store the information for future purposes.

The comprehensive and granular information stored within the intelligent communicative agent register, encompassing agent identification, training data lineage, data processing protocols for various defined data types (including Factual Immutable, Factual Mutable, Historical Preferences, Current Preferences, and Inferred Data), inter-agent interaction definitions, and nuanced behavioral attributes (via the miscellaneous engine), collectively serves as a foundational element for advanced AI governance. This structured registration enables enhanced transparency, facilitates auditable trails for agent behavior and decision-making, and supports the enforcement of ethical guidelines and regulatory compliance. For instance, by clearly defining the types of data an agent is authorized to process, the system allows for more effective oversight against unauthorized data access or misuse, thereby fostering a more trustworthy AI ecosystem.

In an aspect, the one or more intelligent communicative agents are trained based on the information stored in the intelligent communicative agent register.

In an aspect, the intelligent communicative agent register comprises an identification engine configured to store information related to identifying attributes, present operational status, intended use and authentication details of the one or more intelligent communicative agents, a data processing engine configured to store information related to datasets used for training the one or more intelligent communicative agents, an interactive engine configured to store information related to inter communication between the one or more intelligent communicative agents, a data storage engine configured to store information related to volume and type of data the one or more intelligent communicative agents are designated with and/or required to be processed to ensure optimal performance and a miscellaneous engine configured to store information related three dimensional object, mapping of sound, behavioral styles, and predefined principle of operation of the one or more intelligent communicative agents.

In an aspect, the data processing engine of the intelligent communicative agent register is configured to store datasets which may include but are not limited to static data, dynamic data, historic data, and inferred data generated from previous training of the one of more intelligent communicative agents.

In an aspect, the interactive engine of the intelligent communicative agent register is configured to authorize interactions between one or more communicative agents by means of defined intercommunication protocol implementing neural networks.

In an aspect, the data storage engine of the intelligent communicative agent register is configured to store datasets which may include but are not limited to static data, dynamic data, historic data, and inferred data based on normalized risk score generated by the one or more intelligent communicative agents.

In an aspect, the inferred data is generated based on normalized risk score generated by the one or more intelligent communicative agents and behavioral score received by the system through one or more user devices.

In an aspect, the one or more processors comprises of an access control device configured to authenticate access of one or more intelligent communicative agents such that the one or more intelligent communicative agents operate within the predefined field.

In an aspect, the system is configured to allow independent inter-communication between the one or more intelligent communicative agents.

In an aspect, the database may include but is not limited to personal data, health data, lifestyle data, any other data, and combinations thereof.

In an aspect, there is provided a method for registering details of one or more intelligent communicative agents. In an aspect, the method comprises deploying one or more intelligent communicative agents to perform specific task, where each of the one or more intelligent communicative agents are associated with scope of a predefined field, storing information related to the one or more intelligent communicative agents by a memory unit, facilitating interaction between one or more intelligent communicative agents by one or more processors based on field of specific task for which one or more intelligent communicative agents are deployed, generating real time information based on interaction between the one or more intelligent communicative agents by the one or more processors to ensure functioning of the one or more intelligent communicative agents in a cohesive manner, receiving and processing information related to interactions between the one or more intelligent communicative agents from the one or more processors by the central hub, receiving information from the central hub and the one or more processors by the intelligent communicative agent register, recording, storing and managing information related to each intelligent communicative agent of the one or more intelligent communicative agents by the intelligent communicative agent register, receiving as generated real time information by the intelligent communicative agent register by one or more communication networks and transmitting as received real-time information to one or more user devices by means of the one or more communication networks.

In an aspect, the method includes configuring the intelligent communicative agent register to store information related to identifying attributes, present operational status, intended use and authentication details of the one or more intelligent communicative agents by means of the identification engine, store information related to datasets used for training the one or more intelligent communicative agents by means of the data processing engine, store information related to inter communication between the one or more intelligent communicative agents by means of the interactive engine, store information related to volume and type of data the one or more intelligent communicative agents that are designated with and/or required to be processed to ensure optimal performance by means of the data storage engine and store information related three dimensional object, mapping of sound, behavioral styles, and predefined principle of operation of the one or more intelligent communicative agents by means of the miscellaneous engine.

In an aspect, the method includes configuring the interactive engine of the intelligent communicative agent register to authorize interactions between one or more communicative agents by means of defined intercommunication protocol implementing neural networks.

In an aspect, the method includes configuring the data storage engine of the intelligent communicative agent register to store datasets which may include but are not limited to static data, dynamic data, historic data, and inferred data based on normalized risk score generated by the one or more intelligent communicative agents.

In an aspect, the method includes generating inferred data based on normalized risk score generated by the one or more intelligent communicative agents and behavioral score received through one or more user devices.

In an aspect, the method includes configuring the interactive engine of the intelligent communicative agent register to authorize interactions between one or more communicative agents by means of defined intercommunication protocol implementing neural networks.

In an aspect, the method includes authenticating access for one or more intelligent communicative agents by the one or more processors such that the one or more intelligent communicative agents operate within the predefined field.

In an aspect, the method includes allowing independent inter-communication between the one or more intelligent communicative agents.

A non-transitory machine-readable medium including data, which when used by a system for registering details of one or more intelligent communicative agents, causes the system to perform instructions that cause the system to perform operations, comprising deploying one or more intelligent communicative agents to perform specific task, wherein each of the one or more intelligent communicative agents are associated with scope of a predefined field, storing information related to the one or more intelligent communicative agents by a memory unit, facilitating interaction between one or more intelligent communicative agents by one or more processors based on field of specific task for which one or more intelligent communicative agents are deployed, generating real time information based on interaction between the one or more intelligent communicative agents by the one or more processors to ensure functioning of the one or more intelligent communicative agents in a cohesive manner, receiving and processing information related to interactions between the one or more intelligent communicative agents from the one or more processors by a central hub, receiving information from the central hub and the one or more processors by an intelligent communicative agent register, recording, storing and managing information related to each intelligent communicative agent of the one or more intelligent communicative agents by the intelligent communicative agent register, receiving as generated real time information by the intelligent communicative agent register by one or more communication networks and transmitting as received real-time information to one or more user devices by means of the one or more communication networks.

To further understand the characteristics and technical contents of the present subject matter, a description relating thereto will be made with reference to the accompanying drawings. However, the drawings are illustrative only but not used to limit the scope of the present subject matter.

Various objects, features, aspects, and advantages of the inventive subject matter will become more apparent from the following detailed description of preferred embodiments, along with the accompanying drawing figures in which numerals represent like components.

### BRIEF DESCRIPTION OF THE DRAWINGS

The disclosure will be described and explained with additional specificity and detail with the accompanying figures in which:

FIG. 1 illustrates an exemplary block diagram representation of a network architecture implementing a system for registering of intelligent communicative agents, in accordance with an exemplary embodiment of the present disclosure;

FIG. 2 illustrates an exemplary block diagram representation of a computer implemented system, such as those shown in FIG. 1, capable of registering the intelligent communicative agents, in accordance with an exemplary embodiment of the present disclosure;

FIG. 3 illustrates an exemplary flow diagram representation of registering of intelligent communicative agents, in accordance with an exemplary embodiment of the present disclosure; and

FIG. 4 depicts an example method of operation of the system in accordance with an exemplary embodiment of the present disclosure.

The figures depict embodiments of the present subject matter for the purposes of illustration only. A person skilled in art will easily recognize from the following description that alternative embodiments of the structures and methods illustrated herein may be employed without departing from the principles of the disclosure described herein.

Further, those skilled in art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure provide systems and methods for registering of artificial intelligence (AI) agents.

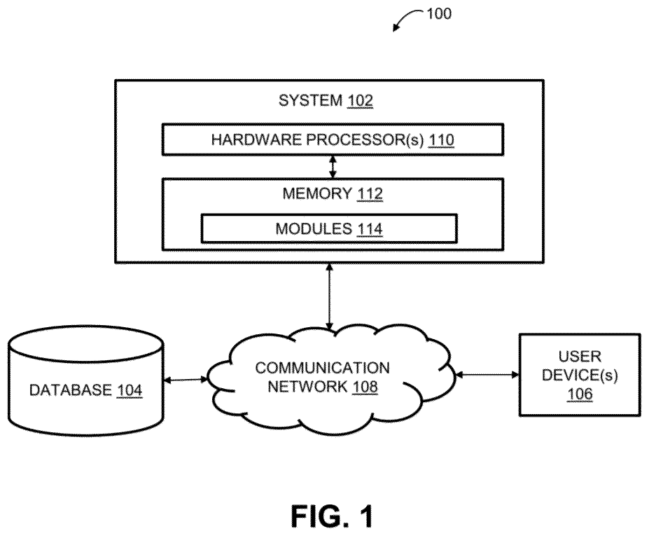

Referring now to the drawings, and more particularly to FIG. 1 through FIG. 4, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture (100) implementing a system (102) for registering of intelligent communicative agents, in accordance with an embodiment of the present disclosure. According to FIG. 1, the network architecture (100) may comprise the system (102), a database (104), and one or more user devices (106). The one or more user devices (106) may be associated with one or more users and communicatively coupled to the system (102) via one or more communication networks (108).

In an exemplary embodiment of the present disclosure, the user devices (106) may include a laptop computer, desktop computer, tablet computer, smartphone, wearable device, a digital camera, and the like. Further, the communication network (108) may be a wired network or a wireless network. The system (102) may be at least one of, but not limited to, a central server, a cloud server, a remote server, an electronic device, a portable device, and the like. Further, the system (102) may be communicatively coupled to the database (104), via the communication network (108). The database (104) may include, but is not limited to, personal data, health data, lifestyle data, any other data, and combinations thereof. The database (104) may be any kind of database/repositories such as, but are not limited to, relational database, dedicated database, dynamic database, monetized database, scalable database, cloud database, distributed database, any other database, and combination thereof.

Further, the user device (106) may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device (106) may be used to provide input and/or receive output to/from the system (102), and/or to the database (104), respectively. The user device (106) may present to the user one or more user interfaces for the user to interact with the system (102) and/or to the database (104) for registering intelligent communicative agents (302) (may also be referred to as an AI agent (302)). The user device (106) may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

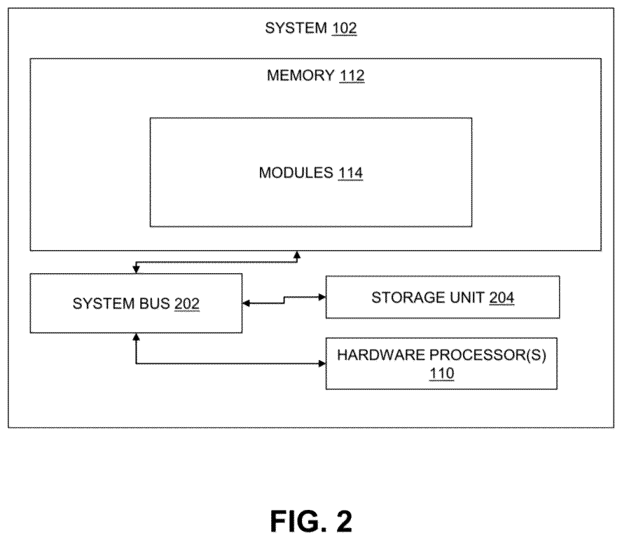

FIG. 2 illustrates an exemplary block diagram representation of a computer implemented system, such as those shown in FIG. 1, capable of registering the intelligent communicative agents, in accordance with an exemplary embodiment of the present disclosure.

In an aspect, the system (102) may comprise of one or more intelligent communicative agents (302), with the one or more intelligent communicative agents (302) being configured to be associated with scope of a predefined field.

In an aspect, the system (102) may further comprise of one or more processors (110), a central hub (304) and an intelligent communicative agent register (306) (may also be referred to as an AI agent register (306)).

In an aspect, the one or more processors (110) are configured to facilitate interaction between one or more intelligent communicative agents (302) and generate real time information based on interactions between the one or more intelligent communicative agents (302). This is pursued to ensure functioning of one or more intelligent communicative agents (302) in a cohesive manner.

In an aspect, the central hub (304) is configured to receive and process information related to the above-mentioned interactions upon receipt of same from the one or more processors (110).

In an aspect, the intelligent communicative agent register (306) acts as a central repository and is configured to receive information from the central hub (304) and the one or more processors (110). This intelligent communicative agent register (306) meticulously stores the specific attributes of each intelligent communicative agent, including its precise location within the system (102).

The intelligent communicative agent register (306) further record, store and manage information related to each intelligent communicative agent of the one or more intelligent communicative agents (302).

In an aspect, the intelligent communicative agent register (306) may comprise of an identification engine (308), a data processing engine (310), an interactive engine, a data storage engine (314) and a miscellaneous engine.

In an aspect, the identification engine (308) is configured to store information related to identifying attributes, present operational status (active, inactive, under maintenance), intended use/capabilities and authentication details of the one or more intelligent communicative agents (302). These details may include but are not limited to unique identity code, developer, deployment date, access rights, roles of the one or more intelligent communicative agents (302).

In an aspect, the data processing engine (310) is configured to store information related to datasets used for training the one or more intelligent communicative agents (302). The data processing engine (310) of the intelligent communicative agent register (306) is configured to store datasets which may include but are not limited to static data, dynamic data, historic data, and inferred data generated from previous training of the one of more intelligent communicative agents (302). Further the data processing engine (310) may also include versioning information related to training data sets of the one or more intelligent communicative agents (302).

In an aspect, the interactive engine (312) is configured to store information related to inter communication between the one or more intelligent communicative agents (302). This may also include dependencies on the respective communicative agents for data or functionality.

In an aspect, the data storage engine (314) is configured to store information related to volume and type of data the one or more intelligent communicative agents (302) are designated and/or required to be processed to ensure optimal performance. The data storage engine (314) of the intelligent communicative agent register (306) is configured to store datasets which may include but are not limited to factual immutable data or static data (for example, user's date of birth, product specifications), factual mutable data or dynamic data (for example, location of user, real time parameter based response like stock prices), historical preferences or data, current preferences and inferred data (e.g., insights derived from actions, behaviors, and historical data) based on normalized risk score and behavioral score received by the system (102) through one or more user devices (106) generated as a result of training or operation of one or more intelligent communicative agents (302).

In this context, it may be noted that the comprehensive and granular information stored within the intelligent communicative agent register (306), encompassing agent identification, training data lineage, data processing protocols for various defined data types (including Factual Immutable, Factual Mutable, Historical Preferences, Current Preferences, and Inferred Data), inter-agent interaction definitions, and nuanced behavioral attributes (via the miscellaneous engine), collectively serves as a foundational element for advanced artificial intelligence (AI) governance. This structured registration enables enhanced transparency, facilitates auditable trails for agent behavior and decision-making, and supports the enforcement of ethical guidelines and regulatory compliance. For instance, by clearly defining the types of data an agent is authorized to process, the system (102) allows for more effective oversight against unauthorized data access or misuse, thereby fostering a more trustworthy AI ecosystem.

In an aspect, the miscellaneous engine is configured to store information defining unique operational and stylistic characteristics of the one or more intelligent communicative agents (302), which may include, but are not limited to: three-dimensional object representations associated with or utilized by the agent; voice and sound mappings (e.g., specific vocal signatures, auditory cues); behavioral styles (e.g., communication tone, interaction patterns, persona attributes); and predefined principles of operation or engagement rules that govern the agent's conduct beyond core functional logic. The registration of these nuanced attributes is critical for managing agent identity, ensuring consistent user experience, and providing a basis for verifying agent authenticity or detecting deviations from established behavioral norms.

In an aspect, the one or more communication networks (108) are configured to facilitate transmission of information between the one or more intelligent communicative agents (302), the central hub (304) and the intelligent communicative agent register (306). The one or more communication networks (108) are further configured to receive as generated real time information by the intelligent communicative agent register (306) and further transmit same to one or more user devices (106) communicatively coupled with the system (102).

In an aspect, it may be noted in this context that the one or more intelligent communicative agents (302) are being trained based on the information stored in the intelligent communicative agent register (306).

In an aspect, the interactive engine (312) of the intelligent communicative agent register (306) is configured to authorize interactions between one or more communicative agents (302) by means of defined intercommunication protocol implementing neural networks.

In an aspect, the one or more processors (110) comprise of an access control device configured to authenticate access of one or more intelligent communicative agents (302) such that the one or more intelligent communicative agents (302) operate within the predefined field.

In an aspect, the system (102) is configured to allow independent inter-communication between the one or more intelligent communicative agents (302).

In an aspect, the database (104) may include but is not limited to personal data, health data, lifestyle data, any other data, and combinations thereof.

In an aspect, the memory (112) may include a plurality of modules (114). The system (102) may be a hardware device including the one or more processors (110) executing machine-readable program instructions for registering of intelligent communicative agents. Execution of the machine-readable program instructions by the one or more processors (110) may enable the proposed system (102) to register intelligent communicative agents. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more processors (110) may include, for example, microprocessors, microcomputers, microcontrollers, digital signal processors, central processing units, state machines, logic circuits, and/or any devices that manipulate data or signals based on operational instructions. Among other capabilities, one or more processors (110) may fetch and execute computer-readable instructions in the memory (112) operationally coupled with the system (102) for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, sensors, any other devices, and combination thereof. The person skilled in the art should not be limiting the components/subsystems shown in FIG. 1. Although FIG. 1 illustrates the system (102), and one or more user device (106) connected to the database (104), one skilled in the art can envision that the system (102), and the user device can be connected to several user devices located at various locations and several databases via the one or more communication network (108).

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system (102) as is unique to the present disclosure or necessary for an understanding of the present disclosure is depicted and described. The remainder of the construction and operation of the system (102) may conform to any of the various current implementations and practices that were known in art.

In an exemplary embodiment, the system (102) may function as the central hub for storing comprehensive details about each intelligent communicative agent, such as its training data, the volume of data it requires for optimal performance, and its interactions with other agents. Further the system (102) streamlines the process of discovering, assessing, and overseeing intelligent communicative agents, ensuring a structured and efficient approach to their management.

The one or more processors (110), as used herein, means any type of computational circuit, such as, but not limited to, a microprocessor unit, microcontroller, complex instruction set computing exceptionally long processor unit, reduced instruction set computing microprocessor unit, very long instruction word microprocessor unit, explicitly parallel instruction computing microprocessor unit, graphics processing unit, digital signal processing unit, or any other type of processing circuit. The one or more processors (110) may also include embedded controllers, such as generic or programmable logic devices or arrays, application-specific integrated circuits, single-chip computers, and the like.

The memory (112) may be a non-transitory volatile memory and a non-volatile memory. The memory (112) may be coupled to communicate with the one or more processors (110), such as being a computer-readable storage medium. The one or more processors (110) may execute machine-readable instructions and/or source code stored in the memory (112). A variety of machine-readable instructions may be stored in and accessed from the memory (112). The memory (112) may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like.

In an embodiment, the memory (112) may include the plurality of modules (114) stored in the form of machine-readable instructions on any of the above-mentioned storage media and may be in communication with and executed by the one or more processors (110).

In an embodiment, the storage unit (204) may be a cloud storage or a repository such as those shown in FIG. 1. The storage unit (204) may store, but is not limited to, agent profiles, training data, interaction records, data volume requirements, agent interactions, agent location, performance metrics, agent metadata, security logs, registration information, user preferences and any other data, and combinations thereof. The storage unit (204) may be any kind of database/repositories such as, but are not limited to, relational database, dedicated database, dynamic database, monetized database, scalable database, cloud database, distributed database, any other database, and combination thereof.

In an exemplary embodiment, the plurality of modules (114) may register one or more intelligent communicative agents (302), where the intelligent communicative agent register (306) may serve as a centralized repository for accurate agent identification and management.

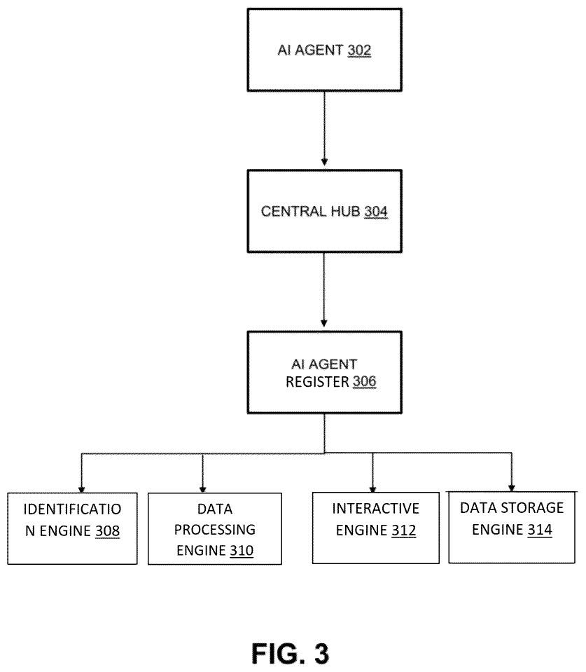

FIG. 3 illustrates an exemplary flow diagram representation of registration of intelligent communicative agents (302), in accordance with an embodiment of the present disclosure. The system (102) introduces a registration process for intelligent communicative agents (302), which is a central hub (304). Further, as already mentioned, the system (102) introduces the intelligent communicative agent (306) for playing a pivotal role as a centralized repository for accurate agent identification and comprehensive management.

Moreover, the system (302) serves as the central hub (304) for preserving intricate details about intelligent communicative agents (302), encompassing vital information from the identification engine (308), data processing engine (310), interactive engine (312), data storage engine (314) as needed for optimal performance, and thus the innovative system (102) streamlines the process of discovering, assessing, and intelligent communicative agents (302), ensuring a structured and efficient approach to their management and fostering a highly organized ecosystem for operation. of intelligent communicative agents (302).

For example, consider a scenario where a company employs a diverse range of intelligent communicative agents (302) to perform various tasks within its operational framework. These intelligent communicative agents (302), for instance, are critical for tasks such as customer support, data analysis, and decision-making processes. To effectively manage this array of agents, the company implements the systems and methods for agent registration. In this setup, the intelligent communicative agent register (302) serves as a centralized database that stores key information about each intelligent communicative agent, including their unique identifiers, functions, and operational locations within the company's network. Additionally, the intelligent communicative agent register (306) records the training data required for each intelligent communicative agent to function optimally and the amount of data these agents need for their tasks. This information is crucial for efficiently allocating resources and ensuring that intelligent communicative agents (302) operate at their peak performance levels. Moreover, the intelligent communicative agent register (306) keeps track of how these agents (302) interact with each other, which is essential for maintaining a harmonious and effective ecosystem. Through this systematic registration process, the company can easily monitor, update, and optimize the intelligent communicative agents (302), leading to enhanced productivity, streamlined operations, and improved overall performance. Therefore, the systems and methods for intelligent communicative agent registration provide the company with a comprehensive solution for managing its AI agent workforce effectively.

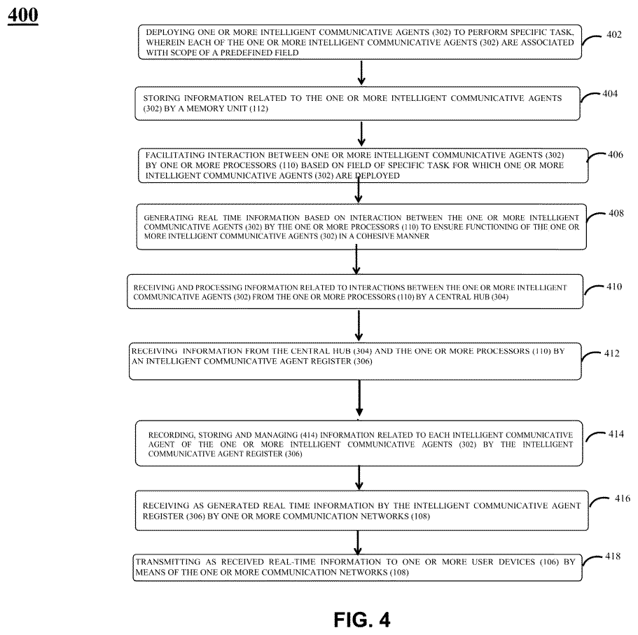

FIG. 4 depicts an example method of operation of the system (102) in accordance with an exemplary embodiment of the present disclosure. The order in which the method (400) is described is not intended to be construed as a limitation, and any number of the described method blocks may be combined in any order to implement the method (400), or an alternative method.

At block (402), the method (400) includes deploying one or more intelligent communicative agents (302) to perform specific tasks, wherein each of the one or more intelligent communicative agents (302) are associated with scope of the predefined field.

At block (404), the method (400) includes storing information related to the one or more intelligent communicative agents (302) by the memory unit (112).

At block (406), the method (400) includes facilitating interaction between one or more intelligent communicative agents (302) by one or more processors (110) based on field of specific task for which one or more intelligent communicative agents (302) are deployed.

At block (408), the method (400) includes generating real time information based on interaction between the one or more intelligent communicative agents (302) by the one or more processors (110) to ensure functioning of the one or more intelligent communicative agents (302) in a cohesive manner.

At block (410), the method (400) includes receiving and processing information related to interactions between the one or more intelligent communicative agents (302) from the one or more processors (110) by the central hub (304).

At block (412), the method (400) includes receiving information from the central hub (304) and the one or more processors (110) by the intelligent communicative agent register (306).

At block (414), the method (400) includes recording, storing and managing information related to each intelligent communicative agent of the one or more intelligent communicative agents (302) by the intelligent communicative agent register (306).

At block (416), the method (400) includes receiving as generated real time information by the intelligent communicative agent register (306) by means of one or more communication networks (108).

At block (418), the method (400) includes transmitting as received real-time information to one or more user devices (106) by means of the one or more communication networks (108).

In an aspect, the method (400) includes configuring the intelligent communicative agent register (306) to store information related to identifying attributes, present operational status, intended use and authentication details of the one or more intelligent communicative agents (302) by means of the identification engine (308), store information related to datasets used for training the one or more intelligent communicative agents (302) by means of the data processing engine (310), store information related to inter communication between the one or more intelligent communicative agents (302) by means of an interactive engine (312), store information related to volume and type of data the one or more intelligent communicative agents (302) that are designated and/or required to be processed to ensure optimal performance by means of the data storage engine (314) and store information related to three dimensional object, mapping of sound, behavioral styles, and predefined principle of operation of the one or more intelligent communicative agents (302) by means of the miscellaneous engine.

In an aspect, the method (400) includes configuring interactive engine (312) of the intelligent communicative agent register (306) to authorize interactions between one or more communicative agents (302) by means of defined intercommunication protocol implementing neural networks.

In an aspect, the method (400) includes configuring data storage engine (314) of the intelligent communicative agent register (306) to store datasets which may include but are not limited to static data, dynamic data, historic data, and inferred data based on normalized risk score generated by the one or more intelligent communicative agents (302) as already mentioned before.

In an aspect, the method (400) includes generating inferred data based on normalized risk score generated by the one or more intelligent communicative agents (302) and behavioral score received through one or more user devices (106).

In an aspect, the method (400) includes configuring the interactive engine (312) of the intelligent communicative agent register (306) to authorize interactions between one or more communicative agents (302) by means of defined intercommunication protocol implementing neural networks.

In an aspect, the method (400) includes authenticating access for one or more intelligent communicative agents (302) by the one or more processors (110) such that the one or more intelligent communicative agents (302) operate within the predefined field.

In an aspect, the method (400) includes allowing independent inter-communication between the one or more intelligent communicative agents (302).

### Exemplary Registration of Intelligent Communicative Agents:

Consider a scenario where a large healthcare facility is managing one or more intelligent communicative agents (302), hereafter referred to as agents, to enhance patient care and streamline medical operations. These agents (302) are deployed for tasks such as diagnosing medical conditions, processing patient records, and even facilitating telehealth consultations. To ensure the seamless and efficient operation of these agents (302), the healthcare facility implements the intelligent communicative agent register (306), hereafter referred to as a register (306) tailored to agent management. The register (306) acts as the central hub (304) that houses critical information about each agent (302). The register (306) meticulously records unique identifiers for each agent, their specific functions, and the precise locations within the healthcare facility where they are employed. Furthermore, it maintains detailed information about the training data contained in the data processing engine (310) as required for each agent to make accurate medical diagnoses and the amount of data to be stored in the data storage engine (314) depending on necessity for handling patient records securely.

The register (306) also monitors the interactions between these agents, helping to prevent conflicts and ensure that the agents (302) work cohesively. Through this comprehensive register (306), the healthcare facility can efficiently manage its agents (302), ensuring that they provide precise and timely medical support to patients, improve operational efficiency, and ultimately contribute to enhanced healthcare services. The systems and methods for agent registration offer an invaluable solution for the healthcare industry, where artificial intelligence (AI) plays a pivotal role in modern medical practices.

### Exemplary Scenario 1

For example, consider a scenario in the realm of autonomous vehicles and smart traffic management within a modern city. To ensure safe and efficient traffic operations, the city employs a diverse fleet of agents (302), ranging from self-driving cars to intelligent traffic signals and infrastructure monitoring. In this bustling metropolis, the effective management of these agents (302) is crucial to maintain smooth traffic flow, reduce congestion, and enhance overall road safety. The city authorities utilize a sophisticated register (306) to centralize the administration of these intelligent entities.

The register (306) records the precise locations of self-driving cars, their areas of operation, and the specific functions they perform, such as autonomous driving, traffic monitoring, or emergency response. Additionally, it keeps track of the training data requirements for each agent, ensuring they have access to real-time traffic information and historical data to make split-second decisions.

Furthermore, the registration system monitors the interactions and collaborations between AI agents. For instance, it oversees the communication between self-driving cars and traffic signals to optimize traffic light patterns based on real-time traffic conditions. It also facilitates coordination between autonomous vehicles to prevent traffic jams and ensure the safe passage of emergency vehicles.

### Exemplary Scenario 2

Consider an expansive e-commerce platform that caters to a global customer base and relies on a multitude of agents (302) to enhance the shopping experience. These agents (302) are responsible for tasks like product recommendations, inventory management, customer support, and logistics optimization. In this bustling digital marketplace, these agents (302) play a pivotal role in ensuring that customers find the products they desire quickly, receive timely assistance, and enjoy a seamless shopping journey. To achieve this, the e-commerce platform has implemented the register (306). The register (306) operates as a centralized repository for the management and oversight of these digital entities. Each agent is meticulously registered within the register (306), with detailed records of their specific functions and responsibilities. For example, product recommendation agents (302) are logged alongside their algorithms and user interaction data, while inventory management AI agents are documented with information on stock levels and replenishment strategies. Moreover, the registration system maintains records of the training data and data volume requirements for each agent (302). This ensures that the recommendation algorithms are continuously updated with the latest product information and customer preferences, allowing them to deliver highly personalized shopping suggestions. The register (306) also monitors interactions between agents to enhance the overall customer experience. When a customer submits an inquiry to the chatbot, the register (306) quickly identifies the most suitable agent to aid based on their unique capabilities and training.

For the sake of brevity, the construction and operational features of the system (102) which are explained in detail above are not explained in detail herein. Particularly, computing machines such as but not limited to internal/external server clusters, quantum computers, desktops, laptops, smartphones, tablets, and wearables may be used to execute the system (102) or may include the structure of the hardware platform. As illustrated, the hardware platform may include additional components not shown, and some of the components described may be removed and/or modified. For example, a computer system with multiple GPUs may be located on external-cloud platforms including Amazon Web Services® (AWS), internal corporate cloud computing clusters, or organizational computing resources.

The hardware platform may be a computer system such as the system (102) that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor that executes software instructions or code stored on a non-transitory computer-readable storage medium to perform methods of the present disclosure. The software code includes, for example, instructions to gather data and analyze the data as the plurality of modules (114).

The instructions on the computer-readable storage medium are read and stored in storage or random-access memory (RAM). The storage may provide a space for keeping static data where at least some instructions could be stored for later execution. The stored instructions may be further compiled to generate other representations of the instructions and dynamically stored in the RAM such as RAM. The processor may read instructions from the RAM and perform actions as instructed.

The computer system may further include the output device to provide at least some of the results of the execution as output including, but not limited to, visual information to users, such as external agents. The output device may include a display on computing devices and virtual reality glasses. For example, the display may be a mobile phone screen or a laptop screen. Graphical user interfaces (GUIs) and/or text may be presented as an output on the display screen. The computer system may further include an input device to provide a user or another device with mechanisms for entering data and/or otherwise interacting with the computer system. The input device may include, for example, a keyboard, a keypad, a mouse, or a touchscreen. Each of these output devices and input devices may be joined by one or more additional peripherals. For example, the output device may be used to display the results such as bot responses by the executable chatbot.

A network communicator may be provided to connect the computer system to a network and in turn to other devices connected to the network including other clients, servers, data stores, and interfaces, for example. A network communicator may include, for example, a network adapter such as a LAN adapter or a wireless adapter. The computer system may include a data source interface to access the data source. The data source may be an information resource. As an example, a database of exceptions and rules may be provided as the data source. Moreover, knowledge repositories and curated data may be other examples of the data source.

The written description describes the subject matter herein to enable any person skilled in art to make and use the embodiments. The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

We claim:

1. A system for registering details of one or more intelligent communicative agents, the system comprising:
one or more intelligent communicative agents, wherein the one or more intelligent communicative agents are configured to be associated with scope of a predefined field;
a memory unit, wherein the memory unit is configured to store information related to the one or more intelligent communicative agents;
one or more processors, wherein the one or more processors are configured to:
facilitate interaction between one or more intelligent communicative agents,
generate real time information based on interaction between the one or more intelligent communicative agents to ensure functioning of the one or more intelligent communicative agents in a cohesive manner;
a central hub configured to receive and process information related to interactions between the one or more intelligent communicative agents from the one or more processors;
an intelligent communicative agent register, wherein the intelligent communicative agent register acts as a central repository and is configured to:
receive information from the central hub and the one or more processors,
record, store and manage information related to each intelligent communicative agent of the one or more intelligent communicative agents;
one or more communication networks, wherein the one or more communication networks are configured to:
facilitate transmission of information between the one or more intelligent communicative agents, the central hub and the intelligent communicative agent register,
receive as generated real time information by the intelligent communicative agent register,
transmit as received real-time information to one or more user devices communicatively coupled to the system; and
a database configured to receive information from the system by means of the one or more communication networks and store the information for future purposes,
and wherein the one or more intelligent communicative agents are trained based on the information stored in the intelligent communicative agent register.

2. The system according to claim 1, wherein the intelligent communicative agent register comprises:
an identification engine configured to store information related to identifying attributes, present operational status, intended use and authentication details of the one or more intelligent communicative agents;
a data processing engine configured to store information related to datasets used for training the one or more intelligent communicative agents;
an interactive engine configured to store information related to inter communication between the one or more intelligent communicative agents;
a data storage engine configured to store information related to volume and type of data the one or more intelligent communicative agents are designated with and/or required to be processed to ensure optimal performance; and
a miscellaneous engine configured to store information related to three dimensional object, mapping of sound, behavioral styles, and predefined principle of operation of the one or more intelligent communicative agents.

3. The system according to claim 2, wherein the data processing engine of the intelligent communicative agent register is configured to store datasets which may include but are not limited to static data, dynamic data, historic data, and inferred data generated from previous training of the one of more intelligent communicative agents.

4. The system according to claim 2, wherein the interactive engine of the intelligent communicative agent register is configured to authorize interactions between one or more communicative agents by means of defined intercommunication protocol implementing neural networks.

5. The system according to claim 2, wherein the data storage engine of the intelligent communicative agent register is configured to store datasets which may include but are not limited to static data, dynamic data, historic data, and inferred data based on normalized risk score generated by the one or more intelligent communicative agents.

6. The system according to claim 5, wherein the inferred data is generated based on normalized risk score generated by the one or more intelligent communicative agents and behavioral score received by the system through one or more user devices.

7. The system according to claim 1, wherein the one or more processors comprises of an access control device configured to authenticate access of one or more intelligent communicative agents such that the one or more intelligent communicative agents operate within the predefined field.

8. The system according to claim 1, wherein the system is configured to allow independent inter-communication between the one or more intelligent communicative agents.

9. The system according to claim 1, wherein the database may include but is not limited to personal data, health data, lifestyle data, any other data, and combinations thereof.

10. A method for registering details of one or more intelligent communicative agents, the method comprising:
deploying one or more intelligent communicative agents to perform specific task, wherein each of the one or more intelligent communicative agents are associated with scope of a predefined field;
storing information related to the one or more intelligent communicative agents by a memory unit;
facilitating interaction between one or more intelligent communicative agents by one or more processors based on field of specific task for which one or more intelligent communicative agents are deployed;
generating real time information based on interaction between the one or more intelligent communicative agents by the one or more processors to ensure functioning of the one or more intelligent communicative agents in a cohesive manner;
receiving and processing information related to interactions between the one or more intelligent communicative agents from the one or more processors by a central hub;
receiving information from the central hub and the one or more processors by an intelligent communicative agent register;
recording, storing and managing information related to each intelligent communicative agent of the one or more intelligent communicative agents by the intelligent communicative agent register;
receiving as generated real time information by the intelligent communicative agent register by one or more communication networks; and
transmitting as received real-time information to one or more user devices by means of the one or more communication networks.

11. The method according to claim 10, wherein the method includes:
configuring the intelligent communicative agent register to:
store information related to identifying attributes, present operational status, intended use and authentication details of the one or more intelligent communicative agents by means of an identification engine;
store information related to datasets used for training of the one or more intelligent communicative agents by means of a data processing engine;
store information related to inter communication between the one or more intelligent communicative agents by means of an interactive engine;
store information related to volume and type of data the one or more intelligent communicative agents that are designated and/or required to be processed to ensure optimal performance by means of a data storage engine; and
store information related to three dimensional object, mapping of sound, behavioral styles, and predefined principle of operation of the one or more intelligent communicative agents by means of a miscellaneous engine.

12. The method according to claim 11, wherein the method includes configuring interactive engine of the intelligent communicative agent register to authorize interactions between one or more communicative agents by means of defined intercommunication protocol implementing neural networks.

13. The method according to claim 11, wherein the method includes configuring data storage engine of the intelligent communicative agent register to store datasets which may include but are not limited to static data, dynamic data, historic data, and inferred data based on normalized risk score generated by the one or more intelligent communicative agents.

14. The method according to claim 13, wherein the method includes generating inferred data based on normalized risk score generated by the one or more intelligent communicative agents and behavioral score received through one or more user devices.

15. The method according to claim 10, wherein the method includes configuring the interactive engine of the intelligent communicative agent register to authorize interactions between one or more communicative agents by means of defined intercommunication protocol implementing neural networks.

16. The method according to claim 10, wherein the method includes authenticating access for one or more intelligent communicative agents by the one or more processors such that the one or more intelligent communicative agents operate within the predefined field.

17. The method according to claim 10, wherein the method includes allowing independent inter-communication between the one or more intelligent communicative agents.

18. A non-transitory machine-readable medium including data, which when used by a system for registering details of one or more intelligent communicative agents, causes the system to perform instructions that cause the system to perform operations, comprising:
deploying one or more intelligent communicative agents to perform specific task, wherein each of the one or more intelligent communicative agents are associated with scope of a predefined field;
storing information related to the one or more intelligent communicative agents by a memory unit;
facilitating interaction between one or more intelligent communicative agents by one or more processors based on field of specific task for which one or more intelligent communicative agents are deployed;
generating real time information based on interaction between the one or more intelligent communicative agents by the one or more processors to ensure functioning of the one or more intelligent communicative agents in a cohesive manner;
receiving and processing information related to interactions between the one or more intelligent communicative agents from the one or more processors by a central hub;
receiving information from the central hub and the one or more processors by an intelligent communicative agent register;
recording, storing and managing information related to each intelligent communicative agent of the one or more intelligent communicative agents by the intelligent communicative agent register;
receiving as generated real time information by the intelligent communicative agent register by one or more communication networks; and
transmitting as received real-time information to one or more user devices by means of the one or more communication networks.
